(19) United States
(12) Patent Application Publication
(10) Pub. No.: US 2024/0217492 A1
(43) Pub. Date: Jul. 4, 2024

(54) VEHICLE BRAKING FORCE CONTROL DEVICE

(71) Applicant: HONDA MOTOR CO., LTD., Tokyo (JP)

(72) Inventors: Tomohiro HOSONO, Tokyo (JP); Kentaro KASUYA, Tokyo (JP); Tomohiro WATANABE, Tokyo (JP); Ryo KOYAMA, Tokyo (JP)

(21) Appl. No.: 18/395,637

(22) Filed: Dec. 25, 2023

(30) Foreign Application Priority Data
Dec. 28, 2022 (CN) 202211699473.6

(51) Int. Cl. B60T 8/1755; B60T 8/24; B60T 8/58

(52) U.S. Cl. CPC B60T 8/17551; B60T 8/246; B60T 8/58; B60T 2201/16; B60T 2220/04; B60T 2250/04

(57) ABSTRACT

A behavior stabilizer of a vehicle braking force control device includes a plurality of first valves configured to control movement of a hydraulic fluid to respective friction brakes, second valves configured to control the movement of the hydraulic fluid to reservoirs, and a drive motor configured to drive pumps that pump the hydraulic fluid from the reservoirs into a path leading to a hydraulic pressure generator. When a vehicle is in a state of turning at a specific vehicle speed or lower, a controller executes a turning control to control operation of an electric actuator to cause the hydraulic pressure generator to generate hydraulic pressure, and to control open/closed states of the first valves and the second valves to apply a braking force to a plurality of wheels. The controller keeps the driving of the drive motor in a stopped state during the turning control.

This application is based on and claims the benefit of priority from Chinese Patent Application No. CN202211699473.6, filed on 28 Dec. 2022, the content of which is incorporated herein by reference.

### BACKGROUND OF THE INVENTION

### Field of the Invention

The present invention relates to a vehicle braking force control device.

### Related Art

In recent years, there has been a growing emphasis on initiatives to provide access to sustainable transportation systems that take into consideration vulnerable traffic participants, such as the elderly, disabled individuals, and children. To achieve this goal, research and development efforts are focused on further improving traffic safety and convenience through advancements of occupant comfort in vehicles.

It is conventionally known in the art to execute turning control (vectoring control) by generating a driving force difference or a braking force difference between the left and right wheels in a situation where a vehicle is required to make a turn with a turning radius smaller than its minimum turning radius, such as when performing a U-turn or parking in a narrow parking space. This type of technology is described, for example, in Japanese Unexamined Patent Application, Publication No. 2011-143753.
Patent Document 1: Japanese Unexamined Patent Application, Publication No. 2011-143753

### SUMMARY OF THE INVENTION

Incidentally, some vehicles perform the turning control using a downstream actuator (for example, one in a vehicle stability assist (VSA) device) rather than an upstream brake actuator (for example, an actuator for operating a slave cylinder) while running. However, such vehicles can have a configuration adopting a pump, which emits loud operating noise, for the downstream actuator. This configuration poses a problem in terms of improving the occupant comfort in the vehicles and raises a demand for an enhancement in quietness during low-speed turning.

An object of the present invention is to provide a vehicle braking force control device that can achieve both good turning performance and quietness of the vehicle during low-speed turning. The present invention, in turn, contributes to the development of a sustainable transportation system.

The present invention relates to a vehicle braking force control device (for example, a vehicle braking force control device 1 described below) for applying a braking force to a vehicle (for example, a vehicle 100 described below), the vehicle braking force control device including: a vehicle speed detector (for example, a vehicle speed detector 11 described below) configured to detect a vehicle speed of the vehicle; a plurality of friction brakes (for example, friction brakes 20a to 20d described below) disposed on a plurality of wheels (for example, wheels 110a to 110d described below) of the vehicle and configured to be driven by hydraulic pressure of a hydraulic fluid; a hydraulic pressure generator (for example, a hydraulic pressure generator 12 described below) configured to generate hydraulic pressure of the hydraulic fluid through operation of an electric actuator (for example, an electric actuator 33 described below); a behavior stabilizer (for example, a behavior stabilizer 21 described below) configured to adjust the hydraulic pressure of the hydraulic fluid supplied from the hydraulic pressure generator and cause the adjusted hydraulic pressure to act on the plurality of friction brakes to stabilize behavior of the vehicle; and a controller (for example, a controller 50 described below) configured to control operation of the behavior stabilizer to adjust the braking force to be applied to the plurality of wheels, the behavior stabilizer including a plurality of first valves (for example, first valves 22a to 22d described below) configured to control movement of the hydraulic fluid to the respective friction brakes, a reservoir (for example, reservoirs 25a and 25b described below) configured to receive the hydraulic fluid discharged from a branch portion of a path (for example, paths 40 described below) of the hydraulic fluid between the plurality of first valves and the plurality of friction brakes, a plurality of second valves (for example, second valves 23a to 23d described below) disposed between the plurality of first valves and the reservoir, and configured to control the movement of the hydraulic fluid to the reservoir, the plurality of second valves being arranged in one-to-one correspondence with the plurality of first valves, a pump (for example, pumps 26a and 26b described below) configured to apply pressure to the hydraulic fluid discharged into the reservoir, and thus pump the hydraulic fluid from the reservoir into a path leading to the hydraulic pressure generator, and a drive motor (for example, a drive motor 27 described below) configured to drive the pump, wherein when the vehicle is in a state of turning at a specific vehicle speed or lower, the controller executes a turning control to control the operation of the electric actuator to cause the hydraulic pressure generator to generate the hydraulic pressure, and to control open/closed states of the first valves and the second valves to apply the braking force to the plurality of wheels, and the controller keeps the driving of the drive motor in a stopped state during the turning control.

This configuration makes it possible to apply a braking force to the wheels using the hydraulic pressure generated by the hydraulic pressure generator during low-speed turning of the vehicle, without using the drive motor for driving the pump, which emits loud operating noise. It is therefore possible to reduce operating noise resulting from the pressurization of the hydraulic fluid, and thus to improve marketability while improving turning performance.

In the turning control, the controller causes the hydraulic pressure generator to generate the hydraulic pressure, and among the plurality of first valves, puts first valves that correspond to the wheels acting as inner wheels during the turning into the open state, and puts first valves that correspond to the wheels acting as outer wheels during the turning into the closed state, to generate a braking force difference between the plurality of wheels.

This configuration makes it possible to generate a braking force difference between the outer wheels and the inner wheels during the turning by opening/closing control of the first valves without using the drive motor for driving the pump, allowing for both enhanced turning performance and enhanced quietness.

The vehicle braking force control device described above further includes a brake operation detector (for example, a brake operation sensor 31 described below) configured to detect an operation of a brake operating element (for example, a brake pedal 30 described below) of the vehicle by a driver, wherein in the turning control, the controller causes the hydraulic pressure generator to generate the hydraulic pressure and puts the plurality of first valves into the open state in a case where the operation of the brake operating element is detected.

This configuration makes it possible to apply the braking force to all the wheels through the pressurization by the opening/closing control of the first valves even in a case where the operation of the brake operating element is detected during the turning control, allowing for prompt braking control while reducing operating noise related to the pressurization of the hydraulic fluid.

The controller causes the hydraulic pressure generator to generate the hydraulic pressure and puts the plurality of first valves into the open state in a case where an operating force on the brake operating element is greater than or equal to a specific level in the turning control, and among the plurality of second valves, puts second valves that correspond to the wheels acting as inner wheels during the turning into the closed state, and puts second valves that correspond to the wheels acting as outer wheels during the turning into the open state, in a case where the operating force on the brake operating element has fallen below the specific level in the turning control.

This configuration makes it possible to reduce the hydraulic pressure on the friction brakes that apply the braking force to the outer wheels during the turning in a case where the operating force on the brake operating element that has been greater than or equal to the specific level falls below the specific level during the turning control. Thus, the above-described configuration allows for prompt pressurization control and depressurization control in response to a change in the operation of the brake operating element.

According to the present invention, it is possible to provide a vehicle braking force control device that can achieve both good turning performance and quietness of the vehicle during low-speed turning.

### BRIEF DESCRIPTION OF THE DRAWINGS

FIG. 1 is a functional block diagram illustrating a configuration of a vehicle braking force control device according to an embodiment of the present invention;

FIG. 2 is a schematic diagram illustrating paths of a hydraulic fluid in the vehicle braking force control device according to the present embodiment;

FIG. 3 is a schematic diagram illustrating a braking force applied to wheels through a first turning control executed by the vehicle braking force control device according to the present embodiment;

FIG. 4 is a schematic diagram illustrating a flow of the hydraulic fluid in the first turning control executed by the vehicle braking force control device according to the present embodiment;

FIG. 5 is a schematic diagram illustrating a braking force applied to the wheels through a second turning control executed by the vehicle braking force control device according to the present embodiment;

FIG. 6 is a schematic diagram illustrating a flow of the hydraulic fluid in the second turning control executed by the vehicle braking force control device according to the present embodiment;

FIG. 7 is a schematic diagram illustrating a braking force applied to the wheels through a third turning control executed by the vehicle braking force control device according to the present embodiment;

FIG. 8 is a schematic diagram illustrating a flow of the hydraulic fluid in the third turning control executed by the vehicle braking force control device according to the present embodiment; and

FIG. 9 is a flowchart showing an example of the flow of processing in low-speed turning control executed by the vehicle braking force control device according to the present embodiment.

### DETAILED DESCRIPTION OF THE INVENTION

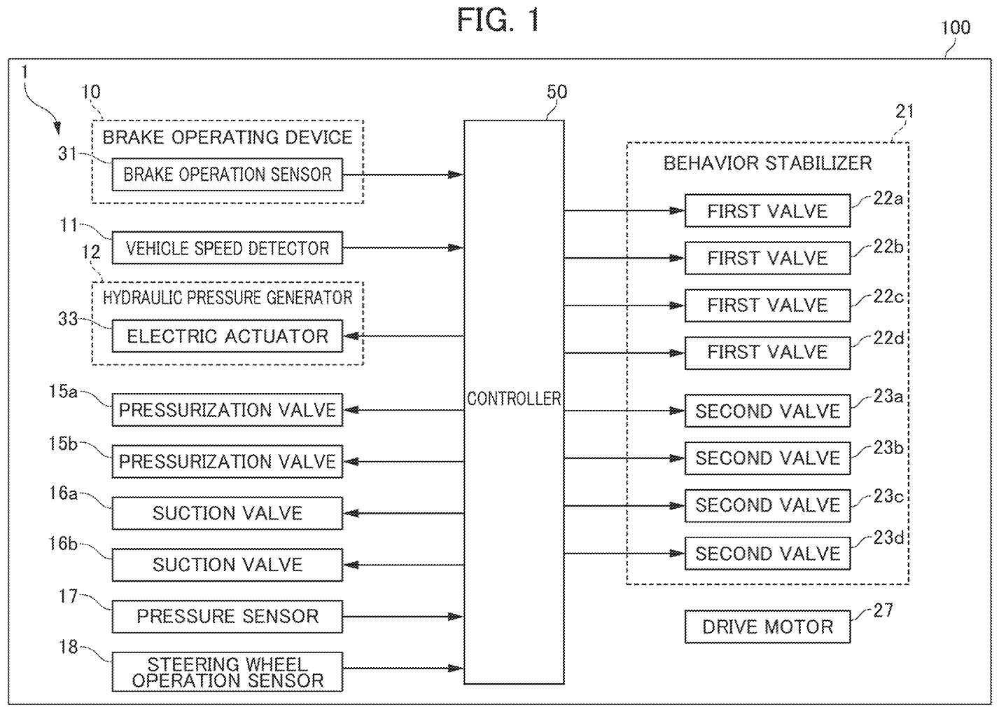

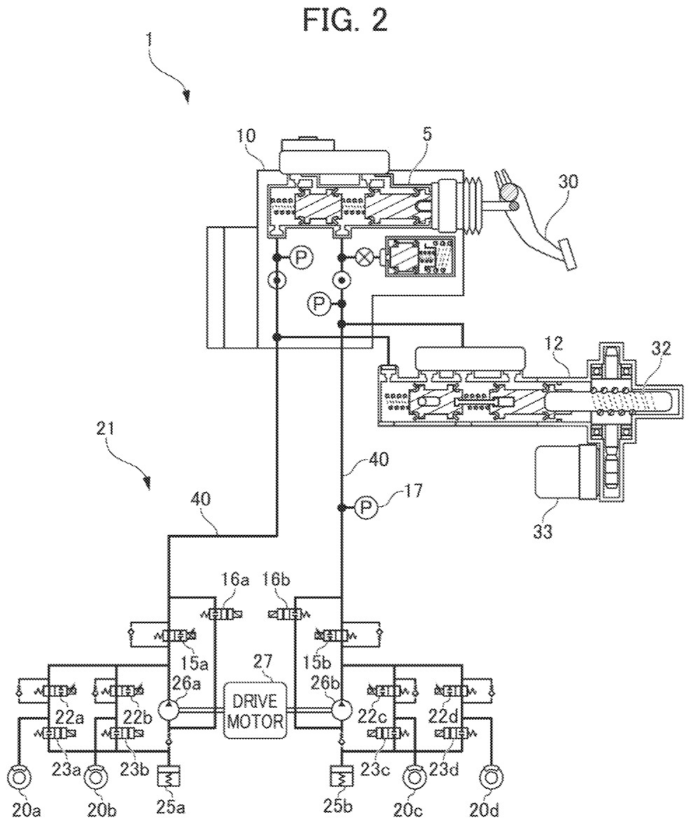

The following describes embodiments of the present invention with reference to the accompanying drawings. Referring to FIGS. 1 and 2, an overall configuration of a vehicle braking force control device 1 that is used for a vehicle 100 will be described. FIG. 1 is a functional block diagram illustrating a configuration of the vehicle braking force control device 1 according to an embodiment of the present invention. FIG. 2 is a schematic diagram illustrating paths 40 of a hydraulic fluid in the vehicle braking force control device 1 according to the present embodiment.

As shown in FIGS. 1 and 2, the vehicle braking force control device 1 includes a brake operating device 10, a vehicle speed detector 11, a hydraulic pressure generator 12, friction brakes 20a to 20d, pressurization valves 15a and 15b, suction valves 16a and 16b, a pressure sensor 17, a behavior stabilizer 21, and a controller 50.

The brake operating device 10 controls the friction brakes 20a to 20d based on operation of a brake pedal 30, which is a brake operating element. The brake operating device 10 is, for example, a brake operating simulator (BOS) that electrically controls the brake operation according to operating force on the brake pedal 30. The brake operating device 10 according to the present embodiment includes a brake operation sensor 31 as a brake operation detector that detects operation information such as operation amount and applied weight based on the movement of a cylinder 5 linked to the operation of the brake pedal 30. The operation information detected by the brake operation sensor 31 is transmitted to the controller 50 and used to control the hydraulic pressure generator 12 described below.

The vehicle speed detector 11 detects vehicle speed, which is the speed of the vehicle 100. The vehicle speed detected by the vehicle speed detector 11 is transmitted to the controller 50.

The hydraulic pressure generator 12 is a slave cylinder that generates hydraulic pressure by moving a piston 32 using an electric actuator 33. The electric actuator 33 operates based on commands from the controller 50. The electric actuator 33 of the present embodiment is a drive device that applies pressure via a ball screw, which emits less operating noise than pumps 26a and 26b described below.

The friction brakes 20a to 20d are wheel cylinders that are disposed on respective wheels of the vehicle 100 and driven by the hydraulic pressure. The friction brake 20a is an RR caliper disposed on the rear right wheel. The friction brake 20b is an FL caliper disposed on the front left wheel. The friction brake 20c is an FR caliper disposed on the front right wheel. The friction brake 20d is an RL caliper disposed on the rear left wheel.

The pressurization valves 15a and 15b operate to pressurize the hydraulic fluid to be supplied to the friction brakes 20a to 20d. The pressurization valve 15a is located upstream of the friction brakes 20a and 20b in the path 40 of the hydraulic fluid, and the pressure valve 15b is located upstream of the friction brakes 20c and 20d in the path 40 of the hydraulic fluid. The pressurization valves 15a and 15b are electrically controlled by the controller 50.

The suction valves 16a and 16b perform a suction operation for returning the hydraulic fluid to a hydraulic pressure generator 12 side. The suction valve 16a is disposed on a friction brakes 20a and 20b side, and the suction valve 16b is located on a friction brakes 20c and 20d side. The suction valves 16a and 16b are electrically controlled by the controller 50.

The pressure sensor 17 is a pressure detector that detects the pressure of the hydraulic fluid that activates the friction brakes 20a to 20d. Pressure information detected by the pressure sensor 17 is transmitted to the controller 50.

A steering wheel operation sensor 18 detects steering operation and transmits such information to the controller 50. The controller 50 determines whether or not the vehicle is performing a turning action based on a value detected by the steering wheel operation sensor 18.

The behavior stabilizer 21 is a vehicle stability assist (VSA) device that adjusts the hydraulic pressure of the hydraulic fluid supplied by the hydraulic pressure generator 12 and causes the adjusted hydraulic pressure to act on the plurality of friction brakes 20a to 20d to stabilize the behavior of the vehicle 100.

The behavior stabilizer 21 of the present embodiment includes first valves 22a to 22d, second valves 23a to 23d, reservoirs 25a and 25b, the pumps 26a and 26b, and a drive motor 27.

The first valves 22a to 22d are pressure holding valves located upstream of the respective friction brakes 20a to 20d in the paths 40 of the hydraulic fluid. The first valve 22a is located upstream of the friction brake 20a. The first valve 22b is located upstream of the friction brake 20b. The first valve 22c is located upstream of the friction brake 20c. The first valve 22d is located upstream of the friction brake 20d. The operation of each of the plurality of first valves 22a to 22d is electrically controlled by the controller 50.

The second valves 23a to 23d are depressurization valves located upstream of the reservoirs 25a and 25b in branch portions of the paths 40 that diverge from downstream sides of the first valves 22a to 22d. The second valve 23a is disposed in the branch portion diverging from the downstream side of the first valve 22a to a reservoir 25a side. The second valve 23b is disposed in the branch portion diverging from the downstream side of the first valve 22b to the reservoir 25a side. The second valve 23c is disposed in the branch portion diverging from the downstream side of the first valve 22c to a reservoir 25b side. The second valve 23d is disposed in the branch portion diverging from the downstream side of the first valve 22d to the reservoir 25b side. The operation of each of the plurality of second valves 23a to 23d is electrically controlled by the controller 50.

The reservoirs 25a and 25b collect the hydraulic fluid discharged from the second valves 23a to 23d. The reservoir 25a collects the hydraulic fluid discharged from the second valves 23a and 23b through the branch portions. The reservoir 25b collects the hydraulic fluid discharged from the second valves 23c and 23d through the branch portions.

The pumps 26a and 26b apply pressure to the hydraulic fluid collected in the reservoirs 25a and 25b, and thus pump the hydraulic fluid into the paths 40 leading to the hydraulic pressure generator 12. The pump 26a applies pressure to the hydraulic fluid in the reservoir 25a, and the pump 26b applies pressure to the hydraulic fluid in the reservoir 25b.

The drive motor 27 transmits driving force to the pumps 26a and 26b to operate the pumps 26a and 26b. The drive motor 27 is electrically driven and controlled by the controller 50. In the present embodiment, the drive motor 27 is kept in a stopped state during low-speed turning and is driven during other traveling states than low-speed turning. It should be noted that in the present embodiment, the drive motor in the stopped state encompasses the drive motor in a substantially stopped state where the drive motor is driven to a degree that does not affect the quietness.

The following describes the controller 50. The controller 50 is a computer that executes various controls related to travel of the vehicle 100 such as a brake operation. The controller 50 includes, for example, a processor, a main storage device such as read only memory (ROM) and random access memory (RAM), and an auxiliary storage device such as storage. The controller 50 may include a single computer or may include a plurality of computers.

The overall configuration of the vehicle braking force control device 1 according to the present embodiment has been described above. The following now describes low-speed turning control of the vehicle 100 using the controller 50 according to the present embodiment.

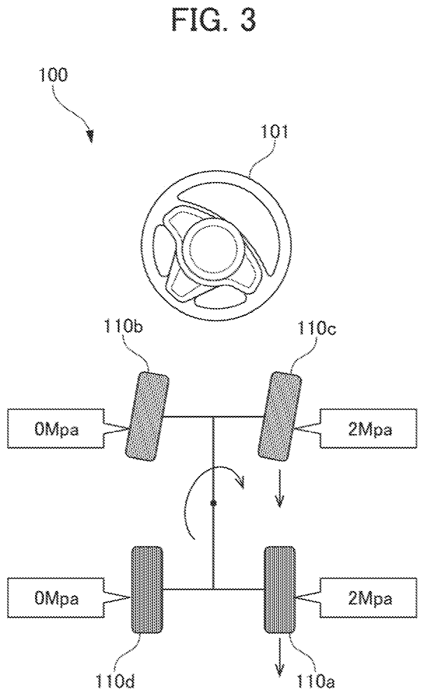

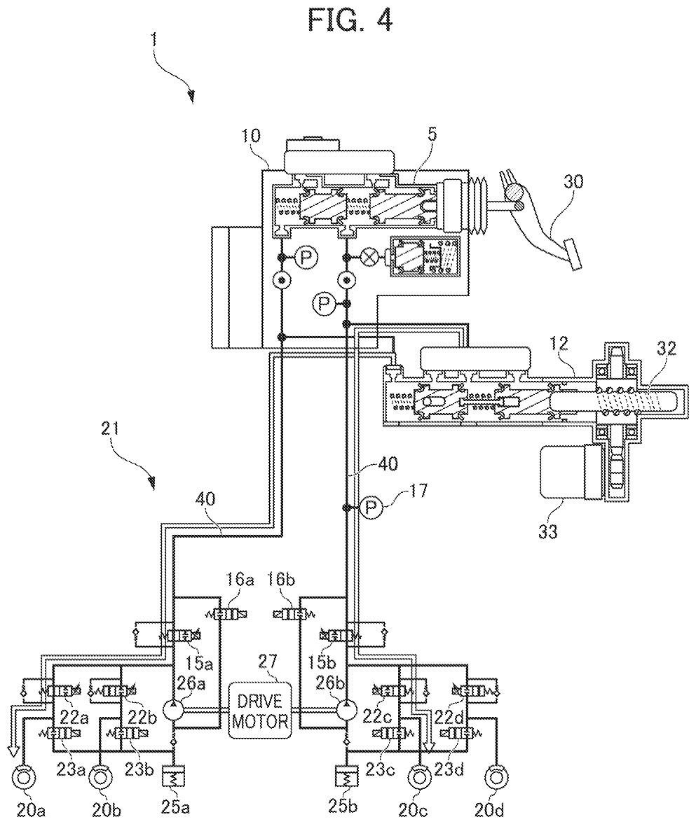

Referring to FIGS. 3 and 4, a first turning control will be described, which is executed in a case where no brake operation is performed during low-speed turning. FIG. 3 is a schematic diagram illustrating a braking force applied to wheels 110a to 110d through the first turning control executed by the vehicle braking force control device 1 according to the present embodiment. FIG. 4 is a schematic diagram illustrating a flow of the hydraulic fluid in the first turning control executed by the vehicle braking force control device 1 according to the present embodiment. In the following description, the wheel 110a is a rear right wheel, the wheel 110b is a front left wheel, the wheel 110c is a front right wheel, and the wheel 110d is a rear left wheel.

The controller 50 executes the first turning control upon the vehicle speed detector 11 detecting that the vehicle 100 is traveling at a preset specific vehicle speed or lower and upon the steering wheel operation sensor 18, which indicates the state of a steering wheel 101, detecting that the vehicle 100 is in a turning state. The specific vehicle speed may be, for example, any value within the range of 5 km/h to 30 km/h, and is not limited to this range as long as the value thereof is set appropriately to determine that the vehicle is in a low-speed state. Whether or not the vehicle 100 is in a turning state may be determined using information other than the information indicating the state of the steering wheel 101 by, for example, directly detecting the state of the wheels. The turning state is not limited to a forward traveling state or a backward traveling state of the vehicle.

In the first turning control, the controller 50 activates the electric actuator 33 to cause the hydraulic pressure generator 12 to apply pressure to the hydraulic fluid to increase the pressure of the hydraulic fluid, and controls open/closed states of the first valves 22a to 22d and the second valves 23a to 23d, to generate a braking force difference between the wheels 110a to 110d. The drive motor 27 is kept in the stopped state during the execution of the first turning control.

The following describes, using right turning as an example, the relationship between the braking force to be applied to the wheels 110a to 110d and the open/closed states of the first valves 22a to 22d and the second valves 23a to 23d in the first turning control. The controller 50 activates the electric actuator 33 to generate hydraulic pressure, and puts the first valves 22a and 22c, which correspond to the wheels 110a and 110c acting as inner wheels during the turning, into the open state. The controller 50 also puts the first valves 22b and 22d, which correspond to the wheels 110b and 110d acting as outer wheels during the turning, into the closed state. Furthermore, in the first turning control, the controller 50 puts all the second valves 23a to 23d, which are provided for sending the hydraulic fluid to the reservoirs 25a and 25b, into the closed state.

As a result of the control to put the first valves 22a and 22c into the open state and to put the first valves 22b and 22d into the closed state, the hydraulic fluid to be supplied to the friction brake 20a for the wheel 110a and the friction brake 20c for the wheel 110c is pressurized, and a braking force (2 Mpa in the example in FIG. 3) is applied to the inner wheels. The hydraulic fluid to be supplied to the friction brakes 20b and 20d corresponding to the outer wheels is not pressurized, and a smaller braking force (0 Mpa in the example in FIG. 3) is applied to the outer wheels. It should be noted that the braking force as used herein may mean the actual braking force being applied or the relative difference between those on the outer wheels and the inner wheels. That is, the braking force difference may be 2 Mpa.

As described above, in the first turning control to be executed during low-speed turning, the pressurization is performed for the inner wheels using the electric actuator 33 of the hydraulic pressure generator 12, which is a slave cylinder, without using the drive motor 27 for driving the pumps 26a and 26b of the behavior stabilizer 21. An example of right turning has been described with reference to FIGS. 3 and 4. The dynamics between the left and right components during left turning are opposite to those during right turning. That is, the controller 50 puts the first valves 22b and 22d, which correspond to the wheels acting as inner wheels during left turning, into the open state, and puts the first valves 22a and 22c, which correspond to the wheels acting as outer wheels during the left turning, into the closed state, among the first valves 22a to 22d.

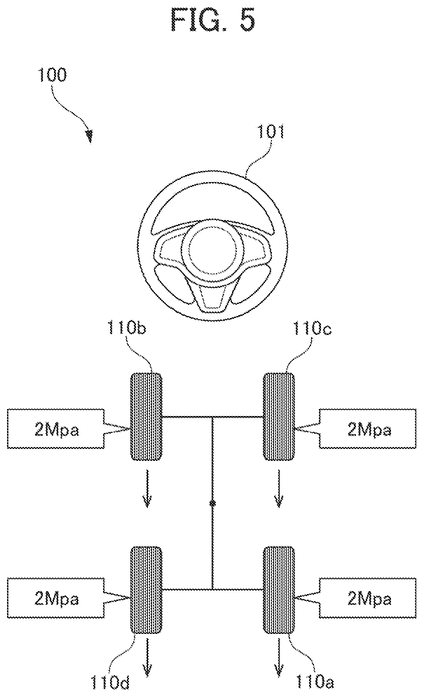

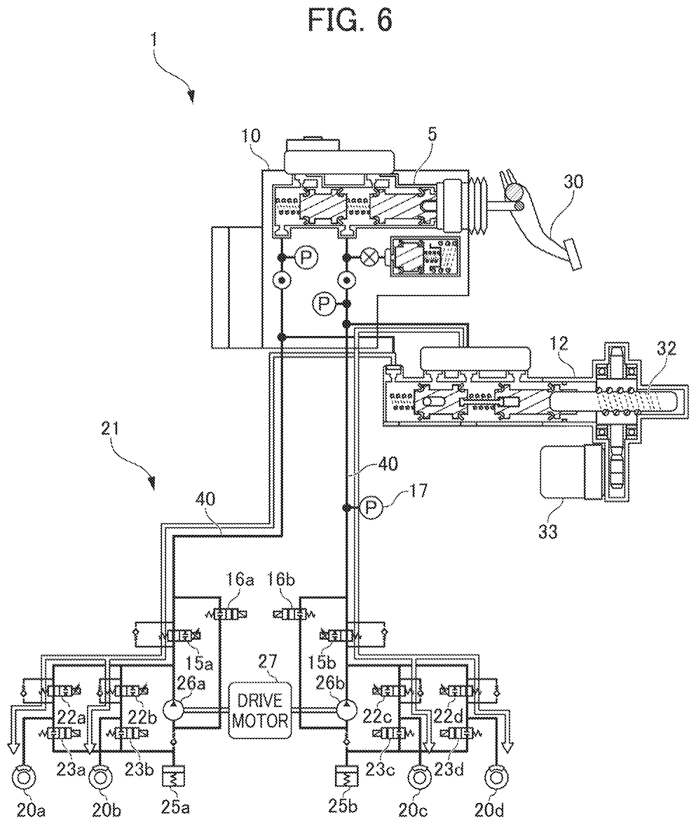

Referring to FIGS. 5 and 6, a second turning control will be described, which is executed in a case where a brake operation is performed with a force greater than or equal to a specific level during low-speed turning. FIG. 5 is a schematic diagram illustrating a braking force applied to the wheels 110a to 110d through the second turning control executed by the vehicle braking force control device 1 according to the present embodiment. FIG. 6 is a schematic diagram illustrating a flow of the hydraulic fluid in the second turning control executed by the vehicle braking force control device 1 according to the present embodiment.

The controller 50 executes the second turning control upon detecting a driver's brake operation with a force greater than or equal to a preset operating force during low-speed turning. The preset operating force is, for example, determined theoretically or empirically as appropriate in the configuration and design of the brake operating device 10.

In the second turning control, the controller 50 activates the electric actuator 33 to cause the hydraulic pressure generator 12 to apply pressure to the hydraulic fluid, and controls open/closed states of the first valves 22a to 22d and the second valves 23a to 23d, to generate a braking force on all the wheels 110a to 110d. The drive motor 27 is kept in the stopped state also during the execution of the second turning control.

During the execution of the second turning control, the controller 50 activates the electric actuator 33 to generate hydraulic pressure, puts all the first valves 22a to 22d into the open state, and puts all the second valves 23a to 23d for sending the hydraulic fluid to the reservoirs 25a and 25b into the closed state. As a result, the hydraulic fluid to be supplied to each of the friction brakes 20a to 20d is pressurized, and a braking force (2 Mpa in the example in FIG. 5) is applied to each of the wheels 110a to 110d.

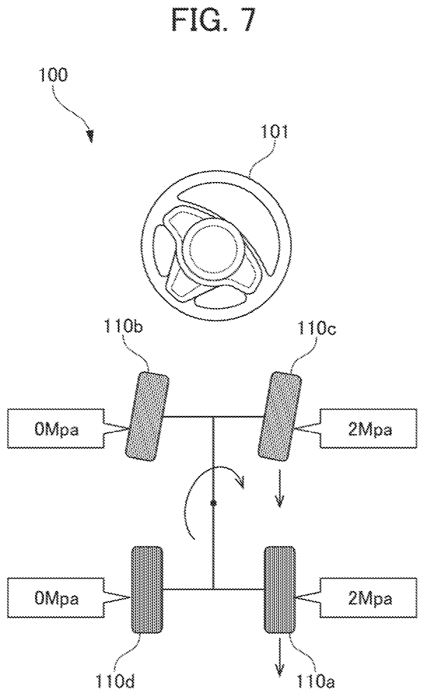

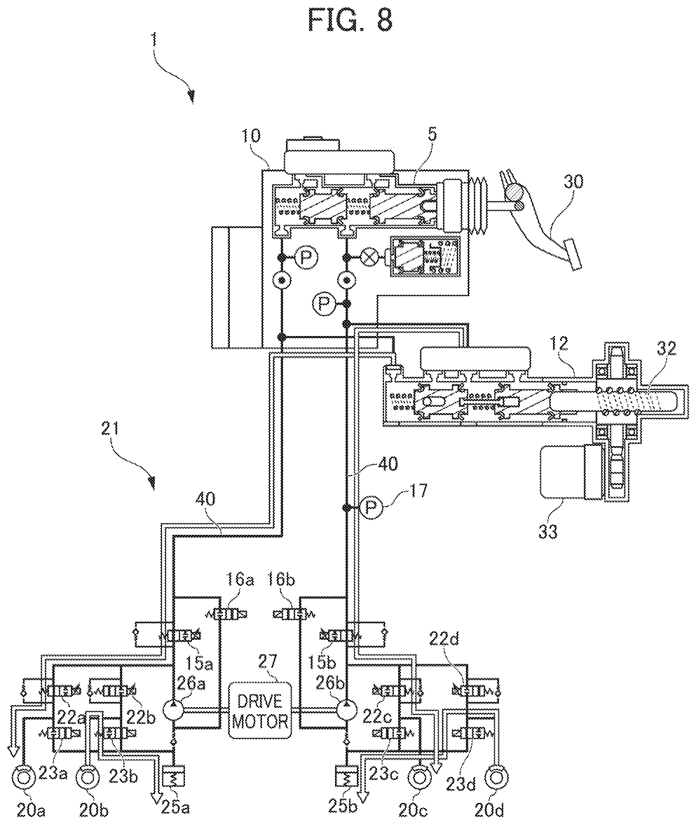

Referring to FIGS. 7 and 8, a third turning control will be described, which is executed in a case where a brake operation is performed with a force less than a specific level during low-speed turning. FIG. 7 is a schematic diagram illustrating a braking force applied to the wheels 110a to 110d through the third turning control executed by the vehicle braking force control device 1 according to the present embodiment. FIG. 8 is a schematic diagram illustrating a flow of the hydraulic fluid in the third turning control executed by the vehicle braking force control device 1 according to the present embodiment.

The controller 50 executes the third turning control upon detecting a brake operation with a force less than a preset operating force during low-speed turning. The preset operating force is, for example, determined theoretically or empirically as appropriate in the configuration and design of the brake operating device 10.

In the third turning control, the controller 50 activates the electric actuator 33 to cause the hydraulic pressure generator 12 to apply pressure to the hydraulic fluid, and controls open/closed states of the first valves 22a to 22d and the second valves 23a to 23d, to generate a braking force difference between the wheels 110a to 110d. The drive motor 27 is kept in the stopped state during the execution of the third turning control.

The following describes, using right turning as an example, the relationship between the braking force to be applied to the wheels 110a to 110d and the open/closed states of the first valves 22a to 22d and the second valves 23a to 23d in the third turning control. The controller 50 activates the electric actuator 33 to generate hydraulic pressure, puts the first valves 22a and 22c into the open state, and puts the first valves 22b and 22d into the closed state. The controller 50 further puts the second valves 23b and 23d, which correspond to the wheels 110b and 110d acting as outer wheels during the turning, into the open state, and puts the second valves 23a and 23c, which correspond to the wheels 110a and 110c acting as inner wheels during the tuning, into the closed state, among the second valves 23a to 23d for sending the hydraulic fluid to the reservoirs 25a and 25b.

As a result of the control to put the first valves 22a and 22c into the open state and to put the first valves 22b and 22d into the closed state, the hydraulic fluid to be supplied to the friction brakes 20a and 20c corresponding to the inner wheels is pressurized, and a braking force (2 Mpa in the example in FIG. 7) is applied to the inner wheels, whereas the hydraulic fluid to be supplied to the friction brakes 20b and 20d corresponding to the outer wheels is discharged into the reservoirs 25a and 25b, and a smaller braking force (0 Mpa in the example in FIG. 7) is applied to the outer wheels. An example of right turning has been described with reference to FIGS. 7 and 8. The dynamics between the left and right components during left turning are opposite to those during right turning.

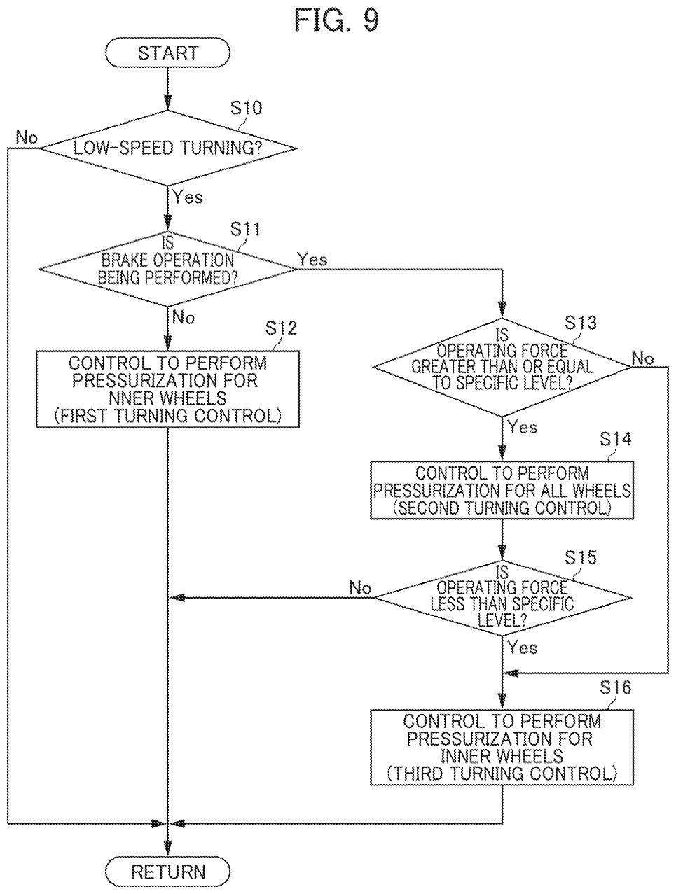

The following describes an example of the flow of overall processing in the low-speed turning control with reference to FIG. 9. FIG. 9 is a flowchart showing an example of the flow of the processing in the low-speed turning control executed by the vehicle braking force control device according to the present embodiment.

First, the controller 50 monitors values detected by detectors such as the vehicle speed detector 11 and the steering wheel operation sensor 18, and determines whether or not the traveling state of the vehicle 100 is a low-speed turning state (Step S10). The controller 50 advances the processing to Step S11 in a case where the traveling state of the vehicle 100 is a low-speed turning state (Yes in Step S10), and returns the processing to continue the monitoring in a case where the traveling state of the vehicle 100 is not a low-speed turning state (No in Step S10).

In Step S11, the controller 50 determines whether or not a brake operation is being performed during low-speed turning. The controller 50 advances the processing to Step S12 in a case where no brake operation is being performed (No in Step S11), and advances the processing to Step S13 in a case where a brake operation is being performed (Yes in Step S11).

In Step S12, the controller 50 executes the first turning control described above, which is a pressurization control to generate a braking force on the wheels acting as inner wheels during the turning. That is, the controller 50 activates the electric actuator 33, opens first valves that correspond to the wheels acting as inner wheels during the turning among the first valves 22a to 22d, closes first valves that correspond to the wheels acting as outer wheels during the turning among the first valves 22a to 22d, and closes all the second valves 23a to 23d. After the process in Step S12, the controller 50 returns the processing to Step S10.

In Step S13, the controller 50 determines whether or not the operating force applied to the brake pedal 30 is greater than or equal to a specific level, or less than the specific level, based on a value detected by the brake operation sensor 31. The controller 50 advances the processing to Step S14 in a case where the operating force is greater than or equal to the specific level (Yes in Step S13), and advances the processing to Step S16 in a case where the operating force is less than the specific level (No in Step S13).

In Step S14, the controller 50 executes the second turning control described above, which is a pressurization control to generate a braking force on all the wheels. That is, the controller 50 activates the electric actuator 33, opens all the first valves 22a to 22d, and closes all the second valves 23a to 23d. After the process in Step S14, the controller 50 advances the processing to Step S15.

In Step S15, the controller 50 determines whether or not the operating force has fallen below the specific level. The controller 50 advances the processing to Step S16 in a case where the operating force has fallen below the specific level (Yes in Step S15), and returns the processing to Step S10 in a case where the operating force has not fallen below the specific level (No in Step S15).

In Step S16, the controller 50 executes the third turning control described above, which is a pressurization control to generate a braking force on the wheels acting as inner wheels during the turning. That is, the controller 50 activates the electric actuator 33, opens all the first valves 22a to 22d, opens second valves that correspond to the wheels acting as outer wheels during the turning among the second valves 23a to 23d, and closes second valves that correspond to the wheels acting as inner wheels during the turning among the second valves 23a to 23d. After the process in Step S16, the controller 50 returns the processing to Step S10.

In the example shown in FIG. 9, the controller 50 switches between different turning controls. The controller 50 switches the turning control from the second turning control to the third turning control in a case where a brake operation is performed during the first turning control. The controller 50 switches the turning control to the first turning control in a case where the brake operation is no longer detected during the execution of the second turning control or the third turning control.

The vehicle braking force control device 1 for applying a braking force to the vehicle 100 according to the present embodiment described above produces the following effects.

A vehicle braking force control device 1 according to the present embodiment includes: a vehicle speed detector 11 configured to detect a vehicle speed of a vehicle 100; a plurality of friction brakes 20a to 20d disposed on a plurality of wheels 110a to 110d of the vehicle 100 and configured to be driven by hydraulic pressure of a hydraulic fluid; a hydraulic pressure generator 12 configured to generate hydraulic pressure of the hydraulic fluid through operation of an electric actuator 33; a behavior stabilizer 21 configured to adjust the hydraulic pressure of the hydraulic fluid supplied from the hydraulic pressure generator 12 and cause the adjusted hydraulic pressure to act on the plurality of friction brakes 20a to 20d to stabilize behavior of the vehicle 100; and a controller 50 configured to control operation of the behavior stabilizer 21 to adjust the braking force to be applied to the plurality of wheels 110a to 110d. The behavior stabilizer 21 includes a plurality of first valves 22a to 22d configured to control movement of the hydraulic fluid to the respective friction brakes 20a to 20d, reservoirs 25a and 25b configured to receive the hydraulic fluid discharged from branch portions of paths 40 of the hydraulic fluid between the plurality of first valves 22a to 22d and the plurality of friction brakes 20a to 22d, a plurality of second valves 23a to 23d disposed between the plurality of first valves 22a to 22d and the reservoirs 25a and 25b, and configured to control the movement of the hydraulic fluid to the reservoirs 25a and 25b, the plurality of second valves 23a to 23d being arranged in one-to-one correspondence with the plurality of first valves 22a to 22d, pumps 26a and 26b configured to apply pressure to the hydraulic fluid discharged into the reservoirs 25a and 25b, and thus pump the hydraulic fluid from the reservoirs 25a and 25b into a path leading to the hydraulic pressure generator 12, and a drive motor 27 configured to drive the pumps 26a and 26b. When the vehicle 100 is in a state of turning at a specific vehicle speed or lower, the controller 50 executes a turning control to control the operation of the electric actuator 33 to cause the hydraulic pressure generator 12 to generate the hydraulic pressure, and to control open/closed states of the first valves 22a to 22d and the second valves 23a to 23d to apply the braking force to the plurality of wheels 110a to 110d. The controller 50 keeps the driving of the drive motor 27 in a stopped state during the turning control.

This configuration makes it possible to apply a braking force to the wheels 110a to 110d using the hydraulic pressure generated by the hydraulic pressure generator 12 during low-speed turning of the vehicle 100, without using the drive motor 27 for driving the pumps 26a and 26b, which emit loud operating noise. It is therefore possible to reduce operating noise resulting from the pressurization of the hydraulic fluid, and thus to improve marketability while improving turning performance.

According to the present embodiment, in the turning control, the controller 50 causes the hydraulic pressure generator 12 to generate the hydraulic pressure, and puts the first valves 22a and 22c (or the first valves 22b and 22d) that correspond to the wheels acting as inner wheels during the turning into the open state, and puts the first valves 22b and 22d (or the first valves 22a and 22c) that correspond to the wheels acting as outer wheels during the turning into the closed state, to generate a braking force difference between the plurality of wheels 110a to 110d.

This configuration makes it possible to generate a braking force difference between the outer wheels and the inner wheels during the turning by opening/closing control of the first valves 22a to 22d without using the drive motor 27 for driving the pumps 26a and 26b, allowing for both enhanced turning performance and enhanced quietness.

The vehicle braking force control device 1 according to the present embodiment further includes a brake operation sensor 31 configured to detect an operation of a brake pedal 30 of the vehicle 100 by a vehicle driver, wherein in the turning control, the controller 50 causes the hydraulic pressure generator 12 to generate the hydraulic pressure and puts the plurality of first valves 22a to 22d into the open state in a case where the operation of the brake pedal 30 is detected.

This configuration makes it possible to apply the braking force to all the wheels 110a to 110d through the pressurization by the opening/closing control of the first valves 22a to 22d even in a case where the operation of the brake pedal 30 is detected during the turning control, allowing for prompt braking control while reducing operating noise related to the pressurization of the hydraulic fluid.

The controller 50 according to the present embodiment causes the hydraulic pressure generator 12 to generate the hydraulic pressure and puts the plurality of first valves 22a to 22d into the open state in a case where an operating force on the brake pedal 30 is greater than or equal to a specific level in the turning control, and puts the second valves 23a and 23c (or the second valves 23b and 23d) that correspond to the wheels acting as inner wheels during the turning into the closed state, and puts the second valves 23b and 23d (or the second valves 23a and 23c) that correspond to the wheels acting as outer wheels during the turning into the open state, in a case where the operating force on the brake pedal 30 has fallen below the specific level in the turning control.

This configuration makes it possible to reduce the hydraulic pressure on the friction brakes 20b and 20d (or the friction brakes 20a and 20c) that apply the braking force to the outer wheels during the turning in a case where the operating force on the brake pedal 30 that has been greater than or equal to the specific level falls below the specific level during the turning control. Thus, the above-described configuration allows for prompt pressurization control and depressurization control in response to a change in the operation of the brake pedal 30.

Although an embodiment of the present invention has been described above, the present invention is not limited to the foregoing embodiment. The effects described in the foregoing embodiment are mentioned just as preferable effects of the present invention. Effects to be produced by the present invention are not limited to those described in the foregoing embodiment.

The foregoing embodiment is not limited to a configuration in which the controller switches between different turning controls. The vehicle braking force control device may have a configuration in which the controller executes only one of the first, second, and third turning controls, or a configuration in which once a turning control is initiated, the controller does not switch to another turning control. As described above, various modifications can be made to the turning controls as appropriate.

### EXPLANATION OF REFERENCE NUMERALS

1: Vehicle braking force control device
11: Vehicle speed detector
12: Hydraulic pressure generator
20a to 20d: Friction brake
21: Behavior stabilizer
22a to 22d: First valve
23a to 23d: Second valve
25a and 25b: Reservoir
26a and 26b: Pump
27: Drive motor
30: Brake pedal (brake operating element)
31: Brake operation sensor (brake operation detector)
33: Electric actuator
50: Controller
100: Vehicle
110a to 110d: Wheel

What is claimed is:

1. A vehicle braking force control device for applying a braking force to a vehicle, the vehicle braking force control device comprising:
a vehicle speed detector configured to detect a vehicle speed of the vehicle;
a plurality of friction brakes disposed on a plurality of wheels of the vehicle and configured to be driven by hydraulic pressure of a hydraulic fluid;
a hydraulic pressure generator configured to generate hydraulic pressure of the hydraulic fluid through operation of an electric actuator;
a behavior stabilizer configured to adjust the hydraulic pressure of the hydraulic fluid supplied from the hydraulic pressure generator and cause the adjusted hydraulic pressure to act on the plurality of friction brakes to stabilize behavior of the vehicle; and
a controller configured to control operation of the behavior stabilizer to adjust the braking force to be applied to the plurality of wheels,
the behavior stabilizer including
a plurality of first valves configured to control movement of the hydraulic fluid to the respective friction brakes,
a reservoir configured to receive the hydraulic fluid discharged from a branch portion of a path of the hydraulic fluid between the plurality of first valves and the plurality of friction brakes,
a plurality of second valves disposed between the plurality of first valves and the reservoir, and configured to control the movement of the hydraulic fluid to the reservoir, the plurality of second valves being arranged in one-to-one correspondence with the plurality of first valves,
a pump configured to apply pressure to the hydraulic fluid discharged into the reservoir, and thus pump the hydraulic fluid from the reservoir into a path leading to the hydraulic pressure generator, and
a drive motor configured to drive the pump, wherein
when the vehicle is in a state of turning at a specific vehicle speed or lower, the controller executes a turning control to control the operation of the electric actuator to cause the hydraulic pressure generator to generate the hydraulic pressure, and to control open/closed states of the first valves and the second valves to apply the braking force to the plurality of wheels, and
the controller keeps the driving of the drive motor in a stopped state during the turning control.

2. The vehicle braking force control device according to claim 1, wherein
in the turning control, the controller causes the hydraulic pressure generator to generate the hydraulic pressure, and among the plurality of first valves, puts first valves that correspond to the wheels acting as inner wheels during the turning into the open state, and puts first valves that correspond to the wheels acting as outer wheels during the turning into the closed state, to generate a braking force difference between the plurality of wheels.

3. The vehicle braking force control device according to claim 2, further comprising
a brake operation detector configured to detect an operation of a brake operating element of the vehicle by a driver, wherein
in the turning control, the controller causes the hydraulic pressure generator to generate the hydraulic pressure and puts the plurality of first valves into the open state in a case where the operation of the brake operating element is detected.

4. The vehicle braking force control device according to claim 3, wherein
the controller
causes the hydraulic pressure generator to generate the hydraulic pressure and puts the plurality of first valves into the open state in a case where an operating force on the brake operating element is greater than or equal to a specific level in the turning control, and
among the plurality of second valves, puts second valves that correspond to the wheels acting as inner wheels during the turning into the closed state, and puts second valves that correspond to the wheels acting as outer wheels during the turning into the open state, in a case where the operating force on the brake operating element has fallen below the specific level in the turning control.
